(19) United States
(12) Patent Application Publication
(10) Pub. No.: US 2016/0025848 A1
(43) Pub. Date: Jan. 28, 2016

(54) DRIVER ASSISTANCE SYSTEM

(71) Applicant: FONDS DE L'ESPCI-GEORGES CHARPAK, Paris (FR)

(72) Inventors: STÉPHANE HOLÉ, PARIS (FR); NABIL HOUDALI, JUVISY SUR ORGE (FR); THIERRY DITCHI, LEUVILLE SUR ORGE (FR); EMMANUEL GÉRON, SANDILLON (FR)

(21) Appl. No.: 14/776,740

(22) PCT Filed: Jan. 17, 2014
(86) PCT No.: PCT/FR2014/000011

§ 371 Date: Sep. 14, 2015

(30) Foreign Application Priority Data
Jan. 22, 2013 (FR) 13/00136

(51) Int. Cl. G01S 13/75

(52) U.S. Cl. CPC G01S 13/753

(57) ABSTRACT

A driver assistance system for supplying information to a vehicle travelling on an infrastructure comprises an electromagnetic wave transmitter, an electromagnetic wave receiver and a processor. The electromagnetic wave transmitter on-board the vehicle comprises at least one transmitting antenna configured to transmit variable-frequency electromagnetic waves to reflectors installed in the infrastructure. The electromagnetic wave receiver on-board the vehicle comprises at least one receiving antenna configured to receive the electromagnetic waves reflected by the reflectors. The processor is configured to extract data representative of the distance between the reflectors and the vehicle from the electromagnetic waves reflected by the reflectors and captured by the electromagnetic waver receiver.

The invention relates, in general, to a guidance device and a guidance system, also called a driver assistance system, of a moving item traveling on an infrastructure and, more specifically, a system using passive electromagnetic reflectors.

In the context of road safety, for example, leaving the road is a cause of many deadly accidents. Therefore, it is important to be able to know at all times the position of the vehicle, independent of the environmental or weather conditions.

Many guidance systems already exist. Amongst these, choosing a detection system that uses magnetism has many advantages. In effect, the magnetic properties of materials are practically unaffected by outside weather conditions such as rain, fog, snow, luminosity, etc.

Guidance systems are already known, which use static magnetic methods utilizing magnetic markings in the form of permanent magnets embedded in the road or in the form of a magnetized strip laid onto or built into the roadway. In the case of permanent magnets, the magnetic detection system onboard the vehicle detects a magnetic field whose attenuation is proportional to the cube of the distance between one of the permanent magnets and the magnetic sensor. In the case of a magnetized strip, the magnetic detection system onboard the vehicle detects a magnetic field whose attenuation is proportional to the square of the distance between the magnetized strip and the magnetic sensor. In both these cases, this leads to very low values of the measured signal as soon as the distance between the source of the magnetic field and the sensor increases and the residual magnetic field of the permanent magnets or of the strip is weak, and consequently, to poor levels of performance of the positioning system. Thus, for permanent magnets with weak residual magnetic fields or for a magnetized strip, their position should be substantially at the center of the traffic lane in order to minimize their distance to the sensors onboard the vehicle when the vehicle is traveling on this roadway. For permanent magnets with stronger magnetic fields, their positioning can be made more off-center on the traffic lane.

The cost of installing permanent magnets or a magnetized strip embedded into the roadway is very high; this limits their installation and consequently the impact on safety improvement, as do the changes likely to be made to the driver assistance system once it has been installed, for example, when roadworks require the roadway to be narrowed.

Installing a magnetized strip laid on the surface of the roadway and in the center of the traffic lane risks disrupting the visual aspect of the roadway and consequently causing risks for the driver if the latter mistakes the magnetized strip for the ground markings. Installing a magnetized strip under or near the ground markings would not let the vehicle's onboard sensors detect the magnetic field produced by the magnetized strip and would therefore make the driver assistance system unusable.

It is also known to use a magnetic field produced by passing an alternative current in one or more wires embedded in the roadway. The alternative magnetic field is easier to detect, even at magnetic field amplitudes that are substantially weaker than those produced by permanent magnets or by a magnetized strip. The installation cost remains high, however, due to burying the wires, which requires a permanent power source to supply alternative current to said wires and the device becomes unusable when there is a break in one of said wires, since this would prevent the electrical current from passing and therefore from producing the magnetic field require to detect said broken wire by the onboard sensors in the vehicle traveling on the roadway.

The goal of the present invention is to propose an innovative driver assistance system, comprising in particular electromagnetic wave reflectors laid beneath the ground markings or within the infrastructure that are cheap to install, maintain and upgrade, and onboard systems in the vehicle that enable the transmission and reception of electromagnetic waves and the appropriate processing of the signals for this driver assistance system. When the reflectors are arranged beneath the ground markings, they can also be used to quantify the condition of said ground markings and therefore to optimize their maintenance.

To this end, the subject of a first aspect of the present invention is a driver assistance device for supplying items of information to a vehicle travelling on an infrastructure, comprising:

means of transmitting electromagnetic waves, onboard said vehicle and comprising at least one transmitting antenna arranged to transmit variable frequency electromagnetic waves towards reflectors installed within the infrastructure,

means of receiving electromagnetic waves, onboard said vehicle and comprising at least one receiving antenna arranged to receive the electromagnetic waves reflected by said reflectors, and

processing means, configured to extract the electromagnetic waves reflected by said reflectors and captured by the receiving means, making it possible to determine the distance between said reflectors and the vehicle.

According to one embodiment of the invention, the frequency of the transmitted electromagnetic waves is below 1 GHz. Preferably, the frequency of the transmitted electromagnetic waves is between 100 MHz and 1 GHz. This frequency range allows for penetration in water.

According to one embodiment of the invention, the processing means are configured to detect, based on the reflected electromagnetic waves, the resonance modes of the reflectors to determine the distance between said reflectors and the vehicle.

According to one embodiment of the invention, the processing means are configured to determine the distance between the reflectors and the vehicle based on the phase of the detected resonance modes.

According to one embodiment of the invention, the processing means are configured to extract, from the reflected electromagnetic waves, data stored by the reflectors.

According to one embodiment of the invention, the processing means are configured to determine data stored by the reflectors based on the amplitude of the detected resonance modes.

According to one embodiment of the invention, the transmitting means are configured to transmit electromagnetic waves at a slowly-variable frequency towards the reflectors.

According to one embodiment of the invention, the receiving means are configured to convert the captured electromagnetic waves into an electrical signal with the same frequency.

According to one embodiment of the invention, the processing means are configured to compare the amplitude and/or the phase of electromagnetic waves captured by the receiving means to the amplitude and/or the phase of the electromagnetic waves transmitted by the transmitting means.

According to one embodiment of the invention, the processing means are configured to process the changes of said amplitude and/or said phase as a function of the frequency of the electromagnetic waves transmitted by the transmitting means to detect, within the surrounding electromagnetic noise, the resonance modes imposed by the reflectors in order to calculate the position of the vehicle in regards to that of said reflectors.

According to one embodiment of the invention, the transmitting means are configured to transmit the electromagnetic waves in pulses separated by regular time intervals.

According to one embodiment of the invention, the processing means are configured to multiply the electrical signal received from the receiving means by a reference signal to determine the amplitude and the phase of the electromagnetic waves captured by the receiving means as a function of the frequency of the electromagnetic waves produced by the transmitting means.

According to one embodiment of the invention, said at least one antenna of the transmitting means and said at least one antenna of the receiving means comprise cross-polarizations, each being at an angle substantially around 45° in relation to the polarization of the reflectors.

According to one embodiment of the invention, said at least one antenna of the transmitting means is placed at a position where the radiation of said at least one transmitting antenna has a low level towards said at least one antenna of the receiving means and/or the collection of said at least one antenna of the receiving means has a low level incoming from said at least one antenna of the transmitting means.

According to one embodiment of the invention, an absorbent material arranged to block the electromagnetic waves is placed between said at least one antenna of the transmitting means and said at least one antenna of the receiving means.

In one embodiment, the transmitting means are configured to transmit electromagnetic waves at a slowly-variable frequency towards the reflectors. In this embodiment, the reflectors are configured to react by sending back electromagnetic waves, of the same frequency and with an amplitude that is more or less pronounced as a function of the resonance modes of said reflectors, towards the receiving means. In this embodiment, the receiving means are configured to convert the captured electromagnetic waves into an electrical signal with the same frequency and to transmit this electrical signal to the processing means. In one embodiment, the processing means are configured to extract the amplitude and the phase of electromagnetic waves captured by the receiving means in relation to those of the electromagnetic waves transmitted by the transmitting means. According to one embodiment, the processing means are configured to process the changes of said amplitude and said phase as a function of the frequency of the electromagnetic waves transmitted by the transmitting means to detect, within the surrounding electromagnetic noise, the resonance modes imposed by the resonators of said reflectors in order to calculate the position of the vehicle in regards to that of said reflectors and determine the information that said reflectors carry, if any.

In a particular embodiment, the transmitting means are configured to transmit the electromagnetic waves in pulses separated by irregular time intervals, such that if there are two vehicles side-by-side, both fitted with a driver assistance system, there will be a temporal window during which only one of the vehicles transmits electromagnetic waves in order to prevent interference. The presence of two vehicles fitted with said device near each other is easily detected on the amplitude of the electromagnetic waves captured by the receiving means when two vehicles transmit at the same time. When a single vehicle transmits electromagnetic waves, the signal produced by the receiving means is transmitted to the processing means. In one embodiment, the processing means are configured to multiply the electrical signal received from the receiving means by a reference signal to determine the amplitude and the phase of the electromagnetic waves captured by the receiving means as a function of the frequency of the electromagnetic waves produced by the transmitting means. The processing means are configured to detect the resonance modes of the reflectors and to extract them from the noise. This makes it possible to estimate the amplitude of the waves reflected by the reflectors and the phase of these waves in relation to that of the transmitted waves. The amplitude of the detected resonance modes represents the items of information stored by the reflectors and the phase represents the distance between the reflectors and the vehicle.

In another embodiment, the transmitting and receiving antennas can be separated to avoid using specific microwave components such as, e.g. circulators and couplers. It is advantageous, in this case, to arrange the antennas in cross-polarization so that they do not interfere with each other too much, each being at an angle substantially around 45° in relation to the polarization of the reflectors, to maximize the signal. Another advantageous solution, according to one embodiment of the invention, consists of placing the antennas at positions where the level of the radiation of the transmitting antennas is weak towards the receiving antennas and/or the collection level of the receiving antennas is low, coming from the transmitting antennas. A variant of the advantageous solution above consists of placing, between the transmitting and receiving antennas, an absorbent material whose purpose is to block the electromagnetic waves that can go directly from said transmitting antennas to said receiving antennas.

In another embodiment, two transmitting and receiving devices are placed on either side of the vehicle so as to detect the reflectors positioned on the right and the reflectors positioned on the left of the traffic lane, making it possible to estimate the relative position of the vehicle in relation to the center of said traffic lane, which is deemed to be the optimum trajectory. This embodiment can be further improved by placing transmitting and receiving devices at the four corners of the vehicle, which makes it possible to estimate, in addition to the position of the vehicle, its angle in relation to the direction of the traffic lane and thus to allow the driver assistance systems to predict the vehicle's exact trajectory more accurately.

In these various embodiments, the antennas may be incorporated into the vehicle at any place that allows the electromagnetic waves produced by the transmitting device to reach the reflectors, and the electromagnetic waves reflected by said reflectors to reach the receiving device, for example, in a non-limiting way, in the bumpers, the door- or wing-trims, the door sills.

Another aspect of the invention presents a vehicle comprising a driver assistance device according to one of the embodiments of the invention.

According to one embodiment of the invention, receiving means and transmitting means are placed on either side of the vehicle so as to detect the reflectors positioned on the right and the reflectors positioned on the left of a traffic lane of the infrastructure.

According to one embodiment of the invention, receiving means and transmitting means are placed at the four outer corners of the vehicle.

The object of a second aspect of the present invention is a driver assistance device installed in a traffic infrastructure comprising electromagnetic wave reflectors arranged so as to reflect electromagnetic waves towards a vehicle traveling on the infrastructure, the device comprising a resonator having one or more resonance modes to modify the power and/or the phase of the waves reflected by said reflectors, as a function of the frequency.

According to one embodiment, said at least one resonator is designed to encode items of information intended for said vehicle. Items of information are encoded using the phase and/or amplitude of the resonance modes.

According to one embodiment, the amplitude of the resonance modes represents one item of information stored by the device.

According to one embodiment, the phase of the resonance modes represents the distance between the reflector and the vehicle.

According to one embodiment, the resonators have different resonance frequencies, each resonance frequency being associated to a different element of the infrastructure.

According to one embodiment, each reflector comprises at least one antenna whose directivity pattern is selected to enable adequate collection and radiation in a plane substantially parallel to a roadway of the infrastructure and in a principal direction substantially perpendicular to the direction of travel.

According to one embodiment, the reflectors are configured to receive electromagnetic waves and to send back electromagnetic waves with the same frequency and with an amplitude that is a function of the resonance modes of said reflector towards the vehicle.

According to one embodiment, the device is fitted within a composition of ground markings.

In one embodiment, each reflector comprises at least one antenna whose directivity pattern is selected to enable adequate collection and radiation in a plane substantially parallel to the roadway and in a principal direction substantially perpendicular to the direction of travel.

According to one embodiment, the resonators are made, for example and in a non-limiting way, of capacitors and inductances, of cavities, or of volume- or surface-wave resonators, whose purpose is to alter the power and/or phase of the waves reflected by the reflectors, as a function of its frequency, so that it is possible to distinguish the reflectors from the surrounding electromagnetic noise. The frequency of the electromagnetic waves used is such as to enable adequate penetration through water, snow or mud, for example.

In one advantageous embodiment, the reflectors have different resonance frequencies, making it possible to distinguish, for example and in a non-limiting way, the different traffic lanes, in particular the right-hand limit of the roadway, the left-hand limit of the roadway and the limits separating two lanes. In this way, the behavior of the driver assistance system can adapt itself according to whether the vehicle is entering a dangerous trajectory, e.g. leaving the road, or whether it simply changing traffic lane, e.g. to overtake another vehicle. These items of information can be encoded by the reflectors by utilizing, for example and in a non-limiting way, the frequency difference between two distinct resonance modes, one given frequency difference being encoded as a binary “0” level, and a different frequency difference being encoded as a binary “1” level. A set of resonance modes can also encode more complex items of information, with the frequency differences between the successive resonance modes being encoded as a more complete message, in the same way as barcodes.

In another embodiment, alternating the reflectors of different resonance modes makes it possible to encode richer and longer items of information than in the previous embodiment, being able to specify information about upcoming dangers linked to the traffic lane, e.g. bends, banking, narrowing of the roadway, or any other information likely to alter the driver's behavior as a function of the foreseeable dangers.

In an additional embodiment, the reflectors are inserted and/or hidden in a ground marking composition, making it possible for specially-equipped vehicles to characterize the density of reflectors present in each ground marking at each passage of the specially-equipped vehicle and consequently to trigger a renovation of the ground markings if they are too degraded, in particular by the loss of a large number of reflectors. The insertion of reflectors within ground markings uses known road signaling techniques, such as those used to incorporate glass beads for reflecting back the light coming from the headlamps of the vehicles.

Another aspect of the invention describes a driver assistance system comprising an onboard device according to one of the embodiments of the first aspect of the invention, and a device installed in a travel infrastructure according to one of the embodiments of the second aspect of the invention.

Other advantages and characteristics of the invention will become apparent from reading the description that follows. It is made solely as an illustration and should be read with reference to the drawings included in an appendix, wherein:

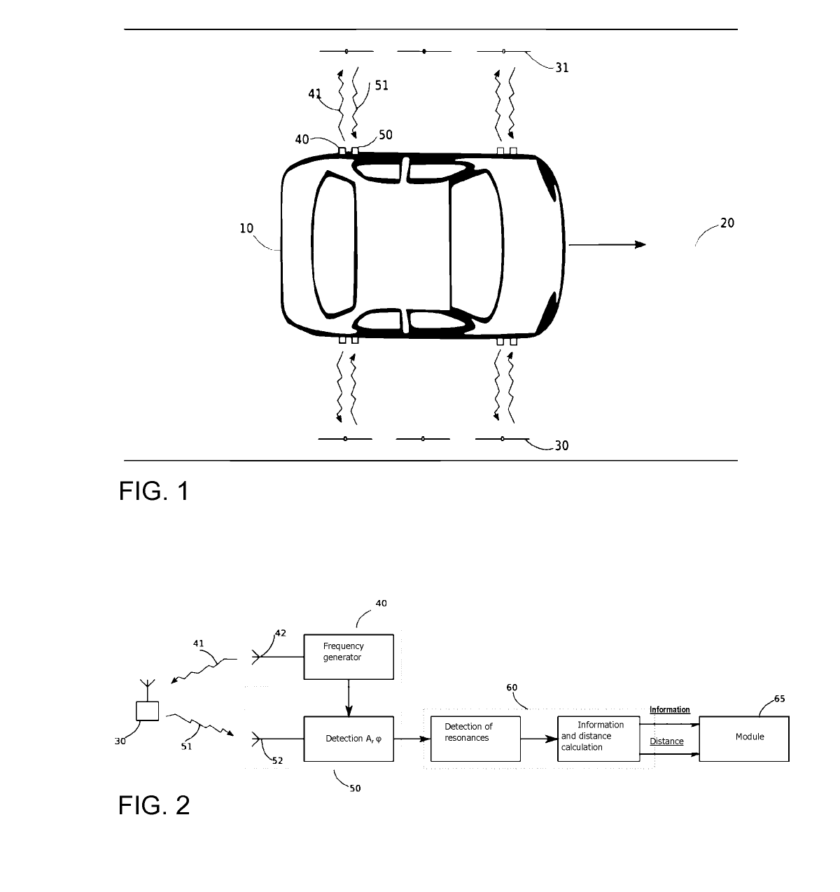

FIG. 1 shows a schematic diagram of the driver assistance system according to at least one embodiment of the invention;

FIG. 2 shows a diagram of a reflector and of the devices onboard the vehicle according to one embodiment of the invention, for the purpose of determining the distance from the vehicle to the reflector;

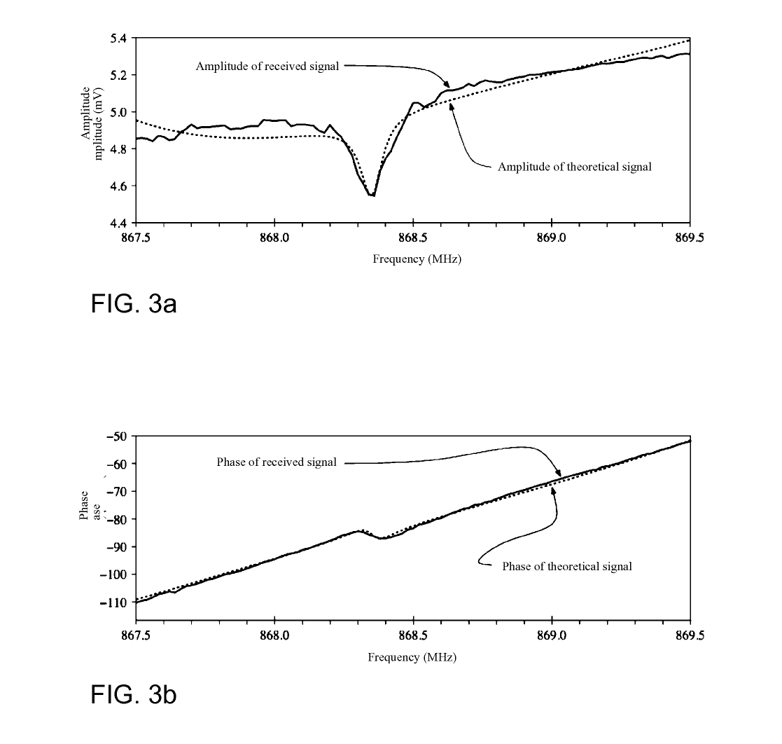

FIG. 3a shows an example of the amplitude of the signal produced by the receiving device as a function of the transmitting frequency within a frequency band about a resonance mode of the reflector, this amplitude being superimposed onto an adjusted theoretical amplitude;

FIG. 3b shows an example of the phase of the signal produced by the receiving device as a function of the transmitting frequency within a frequency band about a resonance mode of the reflector, this phase being superimposed onto an adjusted theoretical phase;

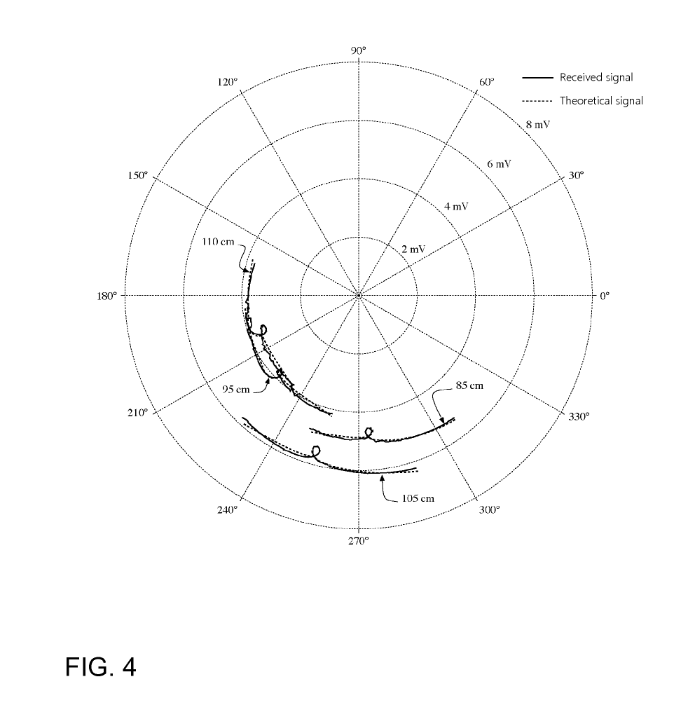

FIG. 4 shows, in a polar representation, the change of the signals produced by the receiving device in the presence of a reflector, for several distances of said reflector, as a function of the transmitting frequency within a band about a resonance mode of said reflector, these signals being superimposed onto adjusted theoretical signals;

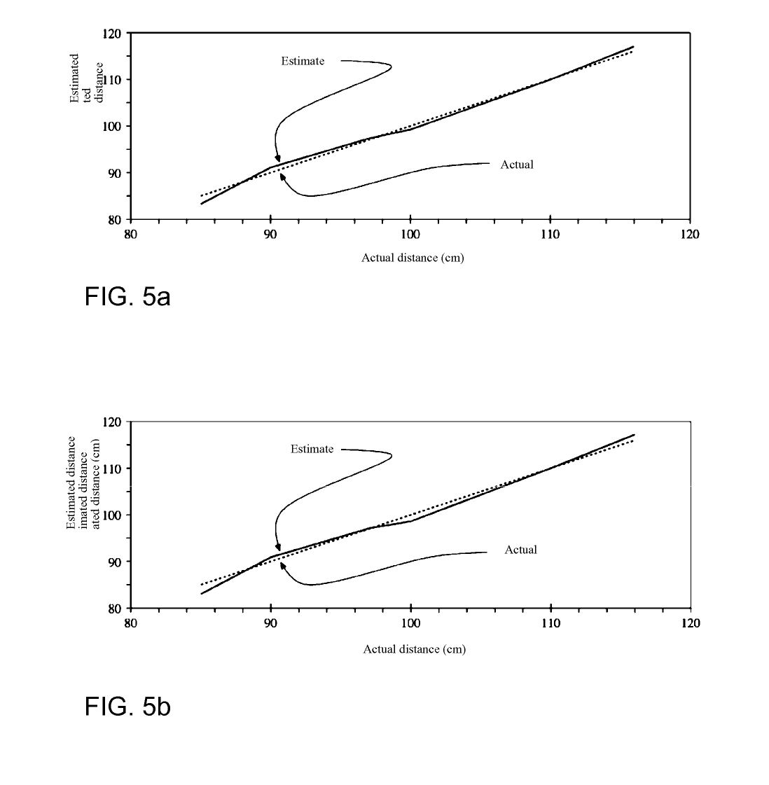

FIG. 5a shows the reflector's distance as calculated by the processing unit compared to said reflector's exact distance in an environment free of disruptive elements;

FIG. 5b shows the reflector's distance as calculated by the processing unit compared to said reflector's exact distance in an environment containing many disruptive elements, such as metal plates and parasitic reflectors, in particular;

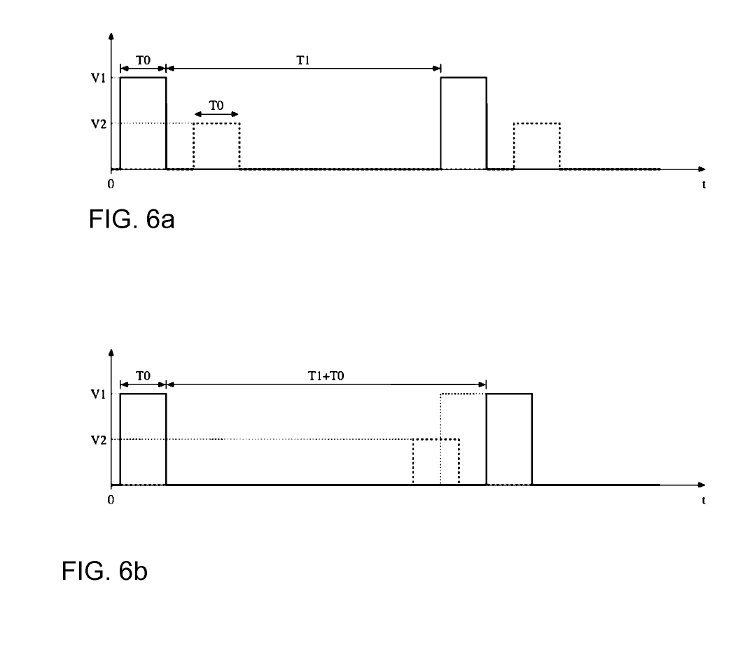

FIG. 6a shows a sequence of standard measurements, with two vehicles fitted with the driver assistance system according to one embodiment of the present invention, both transmitting at different instants with no overlap;

FIG. 6b shows a sequence of measurements, with two vehicles fitted with the driver assistance system according to one embodiment of the present invention, both transmitting at instants where there may be overlap in a standard sequence;

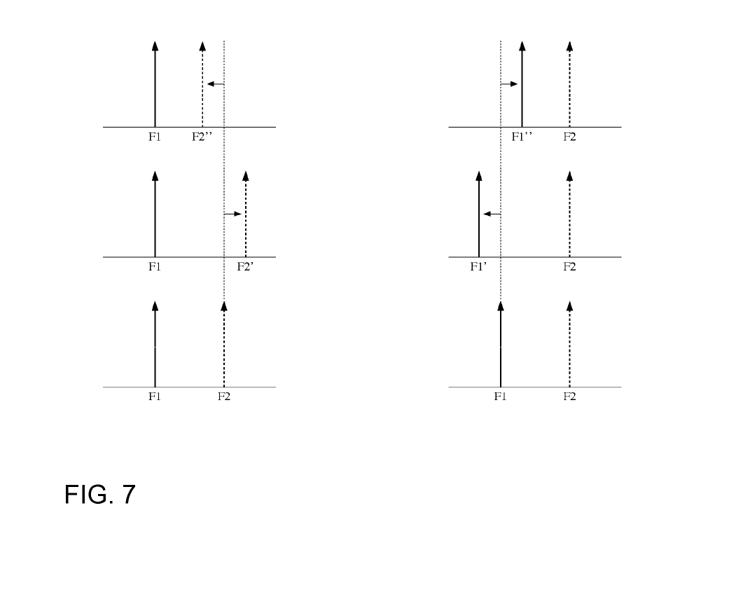

FIG. 7 shows examples of items of information being encoded by the reflectors.

FIG. 1 shows a schematic diagram of the driver assistance system according to at least one embodiment of the invention. In the diagram of FIG. 1, a vehicle 10 is traveling on a road infrastructure 20. “Road infrastructure” means here all of the traffic lanes of a network used for moving mobiles. As well as meaning roads, of course, it can also refer to smaller-scale networks such as traffic lanes within an industrial site, within a building, etc. Reflectors 30 and 31 are arranged on either side of each traffic lane and covered by the ground markings. The reflectors 30 and 31 may be of different kinds, depending on the markings considered, and/or be inserted in a continuous or discontinuous manner so as to encode road-related items of information. Electromagnetic wave transmitting 40 and receiving 50 devices are onboard either side of the vehicle 10 so as to transmit an electromagnetic wave 41 towards the reflectors 30 located on the right-hand and 31 located on the left-hand of the traffic lane and to capture the electromagnetic waves 51 that are reflected by said reflectors. The time taken by the electromagnetic wave to travel from the transmitting device 40 to a reflector 30 then to come back from said reflector to the receiving device 50 is proportional to the distance between the vehicle 10 and said reflector, the scaling factor being the propagation speed of electromagnetic waves c, which is of the order of 300,000 km/s. This round-trip time of the electromagnetic waves shows up in the signal produced by the receiving device by a phase φ that varies as a function of the distance D traversed by the electromagnetic waves according to

φ=2πfD/c

where f is the frequency of the electromagnetic waves transmitted by said transmitting device. The distance D traversed by the electromagnetic waves is proportional to the distance d separating the vehicle and the reflectors. Thus, in the case where the outward distance matches the return distance, i.e. when the transmitting and receiving devices are not too distant from each other, one obtains D=2 d. In the opposite case, a coefficient greater than 2 is used. The benefit of using the phase as the means of estimating the distance between the vehicle and the reflectors is that this makes said estimate independent of the amplitude of the electromagnetic waves captured by the receiving device 50 and therefore independent of the efficiency with which the electromagnetic waves are reflected by the reflectors 30. In order to be effective in any weather conditions, the frequency of the electromagnetic waves produced by the transmitting device should not be too high to prevent too high an attenuation of the electromagnetic waves in water, snow or fog, for example. An electromagnetic wave with a frequency below approximately 1 GHz represents a good compromise. Of course, if the driver assistance system is installed in a position away from bad weather, the frequency of the transmitted electromagnetic waves can be far higher, typically within a 1 GHz to 100 GHz range.

The phase being a periodic function with a 2π radian period, the absolute range of the driver assistance system is limited to one half-period of the phase. For transmitted frequencies below 100 MHz, an absolute range of 1.5 m is achievable, making the driver assistance system according to one embodiment of the invention usable with existing road infrastructures with reflectors having only one resonance mode. However, at higher frequencies, the absolute range is lower, e.g. approximately 173 mm at 868 MHz. Using reflectors with at least two distinct resonance modes or using neighboring reflectors having different resonance modes makes it possible to increase the absolute range of the driver assistance system. As an example for two resonance modes: if the first resonance mode is at a frequency of f1 and the second resonance mode is at a frequency of f2, then the phase φ1 produced by the first resonance mode and the phase φ2 produced by the second resonance mode verify respectively:

D=n1 c/f1+cφ1/(2πf1)

D=n2 c/f2+cφ2/(2πf2)

In these expressions, n1 represents the largest whole number of wavelengths c/f1 of the wave transmitted at the frequency f1, such that n1 c<Df1 and n2 represents the largest whole number of wavelengths c/f2 of the wavelength transmitted at frequency f2 such that n2c<D f2. If f1<f2, then the distance is estimated without ambiguity over an absolute range of c/(f2-f1) by

If φ2>φ1,

then D=c (φ2-φ1)/(2π(f2−f1))

else D=c (φ2-φ1+2π)/(2π(f2−f1))

In this embodiment, the frequency difference f2−f1 is used to increase the absolute range of the distance estimate, but it can also be used to encode information: a given frequency difference could encode a binary “0” level and another frequency difference a binary “1” level.

In the diagram in FIG. 1, the reflectors 30 and 31 being positioned on either side of the traffic lane 20 on which the vehicle 10 is traveling, the ideal position for said vehicle then corresponds to equal horizontal distances between the principal axis of said vehicle and the right-hand reflectors 30 and the left-hand reflectors 31. However, other scenarios are possible, in particular, reflectors incorporated into the roadway coating at any other lateral position of the traffic lane or of the infrastructure. It is assumed in the rest of the description that the reflectors are beneath the ground markings arranged on either side of the traffic lane.

FIG. 2 shows the diagram of one embodiment according to the invention of a reflector 30, of the electromagnetic wave transmitting device 40, of the electromagnetic wave receiving device 50, and of the processing unit 60 making it possible to provide to a module 65 the distance d and the items of information carried by the reflectors based on the electromagnetic waves captured by the receiving device 50 and knowing the electromagnetic waves transmitted by the transmitting device 40. The transmitting 40 and receiving 50 devices are attached to the vehicle by means of a mounting (not shown in the diagram). Said mounting allows the antennas to transmit and receive preferably the electromagnetic waves in a polarization substantially parallel to the infrastructure and substantially oriented along the direction of the traffic lane. Said mounting can be disguised in a non-metallic trim of the vehicle so as to be made invisible in regard of the exterior appearance of the vehicle. The antennas may serve for transmitting only 42, for receiving only 52, or simultaneously for transmitting and receiving, allowing the driver assistance system, which is the subject of the invention, to operate with the lowest possible number of antennas, i.e. a single antenna. For the purposes of clarity, the transmitting antenna 42 and the receiving antenna 52 are separated in the rest of the description. The transmitting 40 and receiving 50 devices are connected to a processing unit 60, which is designed to analyze the signals of the receiving device 50 and, in particular, to determine the distance between the reflectors 30 and the vehicle 10, as well as to read or decode the items of information, if any, encoded by the resonance modes of the reflectors 30.

The onboard devices 40, 50 and 60 can be housed, for example in the vehicle's bumpers or trim. In certain cases, the processing device can be pooled across several transmitting and receiving devices, for example one processing unit can process the signals coming from a receiving device positioned on the right of the vehicle and from another on the left of the vehicle. The distance determined by the processing unit 60 and the decoded items of information are then transmitted to a module 65 that performs several function, such as, e.g. merging data, using the decoded information, transmitting the position of the vehicle to the driver, transmitting the items of information to the driver, etc. Warning messages can be provided to alert the driver to an excessive distancing of the axis of the vehicle in relation to the ideal trajectory symbolized by the center of the traffic lane calculated on the basis of the distances from the vehicle 10 to the right-hand 30 and left-hand 31 reflectors, or of pieces of information encoded by the reflectors according to their resonance modes or to their distribution along the traffic lane (tight bend nearby, upcoming slowdown, etc.) as presented in the rest of the description.

The antennas of the transmitting 40 and receiving 50 devices can advantageously be manufactured with printed circuits in order to obtain flat antennas that are easy to incorporate into the vehicle.

The receiving device 50 captures the surrounding electromagnetic waves made up of electromagnetic noise and the waves reflected by the reflectors. To remove the electromagnetic noise and keep only the electromagnetic waves coming from the reflectors, the electromagnetic noise is approximated with, for example and in a non-limiting way, a polynomial function. The degree of this polynomial function depends on the complexity of the electromagnetic noise encountered and, for the needs of the description, will be set to 3. This choice is non-limiting in regard of the processing and should only be taken as an example. The waves reflected by the reflectors depend in particular on the resonance modes of said reflectors. As an example and with the aim of illustrating the description, a simple resonance will be taken into account. This example must not be seen as limiting in regard of the processing that applies in the same way to more complex resonance modes. The electromagnetic waves received by the receiving device behave in regard of the frequency f of the electromagnetic waves transmitted by the transmitting device according to the theoretical function:

B0+B1f+B2f²+B3f³+Gjff0/(Q(f0²−f²)+jff0)

where
B0, B1, B2 and B3 are the coefficients of the 3rd degree polynomial describing the surrounding electromagnetic noise, these coefficients being complex numbers;
G is the gain of the electromagnetic waves reflected by the reflectors, this gain being a complex number whose phase φ is representative of the distance to be measured, as previously described, and whose module is characteristic of each reflector and therefore likely to carry an item of information if the reflectors do not all have the same transmitting amplitude or if they have several resonance modes each with distinct gains G;
f0 is the frequency of the reflector's resonance mode, likely to carry an item of information if the reflectors do not all have the same frequency f0 or if they have several resonance modes at distinct frequencies;
Q is the quality coefficient of the reflector's resonance mode, likely to carry an item of information if the reflectors do not all have the same quality coefficient Q or if they have several resonance modes at distinct quality coefficients Q;
j is the square root of −1.

The right-hand term of the expression is tailored according to the complexity of the reflectors' resonance modes. If the resonance modes of a reflector are sufficiently distinct, each resonance mode can be processed independently and in similar manner with the expression above. In order to determine the distance between the vehicle and the reflectors according to certain embodiments of the present invention, the processing unit compares the signal sr produced by the receiving device as a function of the frequency of the electromagnetic waves fe transmitted by the transmitting device to the theoretical answer st as a function of said frequency fe and estimates the coefficients B0, B1, B2, B3, G, f0 and Q using, for example and in a non-limiting way, a least squares method. In this method, a criterion J is defined according to

J=Σ_{fe}(sr(fe)−st(fe))²

The minimum for said criterion J, calculated by any known direct or iterative procedure such as the conjugate gradient method, makes it possible to estimate the coefficients B0, B1, B2, B3, G, f0 and Q. FIG. 3a shows the amplitude of a signal received and that of the theoretical signal for the minimum of said criterion J, and FIG. 3b shows the phase of said received signal and that of said theoretical signal for the minimum of said criterion J. FIG. 4 shows, in a polar representation, the module and phase of the signals received for several distances from the onboard devices to the reflector with the theoretical signals calculated by the minimization of said criterion J for each of said distances superimposed onto them. Based on the phase of gain G, the distance d is estimated according to the expressions previously presented.

FIG. 5a shows the comparison between the distance d coming from the processing unit according to the processing described above as a function of the actual distance from the reflector to the onboard devices in a simple situation where only one reflector and the onboard devices are present. FIG. 5b shows the comparison between the distance d coming from the processing unit according to the processing described above as a function of the actual distance from the reflector to the onboard devices in a situation with disruptive elements such as metal plates and the presence of several reflectors.

Results from tests show that the estimate of distance d is not significantly disrupted by the presence of disrupting objects in the reflector's surroundings. The estimation error is better than 1 cm in a measurement range of 70 to 110 cm.

When two vehicles fitted with the driver assistance system according to one embodiment of the present invention pass close to each other, the receiving device of one of the vehicles may be dazzled by the other vehicle's transmitting device if the latter transmits at the same frequency at the same moment. To prevent this problem, an advantageous embodiment of the invention consists in each car's transmitting device transmitting electromagnetic waves in a pulsed manner such that there always exits a time interval during which only one of the vehicles transmits. It should be mentioned that one benefit of the embodiments of the invention is that the electromagnetic waves take very little time to travel from the transmitting device to the reflectors, then from said reflectors to the receiving device, typically under one microsecond, making it possible to carry out measurements over a very short duration, corresponding to a very small movement of the vehicle. As an example, a vehicle traveling at 130 km/h traverses a distance of under 4 mm in 100 μs. By way of description and in a non-limiting way, the transmitting device transmits variable-frequency electromagnetic waves for a duration of T0 and stops operating for a duration of T1, which is strictly greater than T0. If, at the end of the pause T1, no electromagnetic wave coming from another vehicle is detected, then the transmitting procedure is reiterated. If, on the contrary, a wave coming from another vehicle is detected at the end of the pause T1, the pause is extended by a duration T0. Of course, this procedure is only given as an example, and any other procedure aiming to prevent the simultaneous transmitting by several transmitting devices can be envisaged. The total duration of the measurement sequence described in FIG. 6a is T0+T1 and matches, according to the description above, the case of a single vehicle or of several vehicles insofar as each one transmits during the pause T1 of the other transmitting devices. The total duration of the measurement sequence described in FIG. 6b is 2T0+T1 and matches, according to the description above, the case of one vehicle detecting another vehicle's transmission at the end of the pause T1. This pause is consequently extended by a duration T0.

One variant of the driver assistance system consists of adding one or more additional onboard devices in a different position along the principal axis of the vehicle 10. First onboard devices can, for example, be built into the front bumper, whereas second onboard devices can, for example, be built into the rear bumper of the vehicle. In this way, knowledge of the distance calculated as described previously for the first devices, together with knowledge of the second distance produced by the additional devices, make it possible to have access to the orientation of the vehicle's axis in relation to the traffic lane. This data can be very useful for an anti-skid control, for example.

The reflectors may also be laid into the infrastructure by providing a shallow notch for this purpose, so as to then cover them over with another material to fill the notch and ensure increased resilience of the reflectors over time.

The reflectors can serve as a medium for the information by defining successive portions of the reflectors, or primary interval, with a resonance mode frequency and/or quality coefficient that varies in the case of a simple resonator, or frequencies and/or quality coefficients and/or amplitudes of the resonance modes in the case of a more complex resonator attributed to each portion. The portions or intervals may touch (continuous distribution of the reflectors) or not (discontinuous distribution of the reflectors). These intervals, as in the diagram in FIG. 1 (labeled 31 and 32) can be distributed regularly in the length direction of the traffic lane. In a preferred embodiment, the length of the primary intervals is between once and twice the average distance between said reflectors and the onboard devices, so as to optimize the density of information carried by the reflectors, without producing too great a mixture between the items of information of the different reflectors.

The variations of the resonance modes from one interval to the next, irrespective of whether the distribution of the reflectors is continuous or not, can include, for example and in a non-limiting way, a simple change of frequency f0, or a simple frequency difference between two successive resonance modes, making it possible to represent a string of logical “0” and “1” states for a binary encoding of the information. The encoding can be more complex if the various resonance modes that the reflectors can have are taken into account. The quality coefficient or the amplitude of the resonance mode can also be changed. FIG. 7 shows, as an example, several ways to encode items of information, using a single resonance mode where the transmitting frequency is sufficiently weak to guarantee an adequate absolute range, otherwise two resonance modes, or a set of resonance modes for richer encoding.

The items of information encoded by the reflectors can be of different kinds:
infrastructure signaling reminders (unbroken line, broken line, speed limit, yield, no entry, etc.);
topographical data for the infrastructure (slope, radius of curvature of bends, etc.);
temporary information (road works, diversions, etc.).

In the case of temporarily information, specific reflectors can be incorporated, as a non-limiting example, into cones or studs delimiting works areas and thus temporarily redefining the dimensions of the traffic lane for the duration of the roadworks.

Another benefit of the reflectors according to some embodiments of the invention is that in case of a localized loss of reflectors, the detection device will only lose a small number of information bits. Therefore, the driver assistance system carries on functioning in such cases. It can even be envisaged to provide a certain amount of redundancy in the information so as to repeat these items of information several times.

1-31. (canceled)

32. Driver assistance device for supplying information to a vehicle traveling on an infrastructure, comprising:
a transmitter to transmit electromagnetic waves, onboard the vehicle and comprising at least one transmitting antenna arranged to transmit variable frequency electromagnetic waves towards reflectors installed within the infrastructure;
a receiver to receive the electromagnetic waves, onboard the vehicle and comprising at least one receiving antenna arranged to receive the electromagnetic waves reflected by the reflectors; and
a processor, configured to process electromagnetic waves reflected by the reflectors and captured by the receiver, to determine a distance between the reflectors and said vehicle.

33. Device according to claim 32, wherein the processor is configured to detect, based on the reflected electromagnetic waves, resonance modes of the reflectors to determine the distance between the reflectors and the vehicle.

34. Device according to claim 33, wherein the processor is configured to determine the distance between the reflectors and the vehicle based on a phase of the detected resonance modes.

35. Device according to claim 33, wherein the processor is configured to extract, from the reflected electromagnetic waves, data stored by the reflectors based on an amplitude of the detected resonance modes.

36. Device according to claim 35, wherein the processor is configured to determine data stored by the reflectors based on the amplitude of the detected resonance modes.

37. Device according to claim 33, wherein the processor is configured to compare at least one of the amplitude and the phase of the electromagnetic waves captured by the receiver with at least one of the amplitude and the phase of the electromagnetic waves transmitted by the transmitter, and to process changes in at least one of the amplitude and the phase as a function of a frequency of the electromagnetic waves transmitted by the transmitter to detect, within a surrounding electromagnetic noise, the resonance modes imposed by the reflectors to calculate a position of the vehicle with respect to the reflectors.

38. Device according to claim 32, wherein the transmitter is configured to transmit the electromagnetic waves at a variable frequency towards the reflectors.

39. Device according to claim 32, wherein the transmitter is configured to transmit the electromagnetic waves in pulses separated by regular time intervals.

40. Device according to claim 32, wherein said at least one transmitting antenna and said at least one receiving antenna comprise cross-polarizations, each at an angle substantially around 45° with respect to a polarization of the reflectors.

41. Device according to claim 32, wherein said at least one transmitting antenna is placed at a position having a low level radiation transmission towards said at least one receiving antenna or a low level collection of incoming radiation from said at least one transmitting antenna by said at least one receiving antenna.

42. Device according to claim 32, wherein an absorbent material arranged to block the electromagnetic waves is placed between said at least one transmitting antenna and said at least one receiving antenna.

43. Device according to claim 32, wherein the transmitter transmits the electromagnetic waves at a frequency below 1 GHz.

44. Vehicle comprising a driver assistance device according to claim 32.

45. Vehicle according to claim 44, wherein the receiver and the transmitter are placed on either side of the vehicle to detect the reflectors positioned on right and the reflectors positioned on left of a traffic lane of the infrastructure.

46. Driver assistance device installed in a traffic infrastructure, comprising electromagnetic wave reflectors arranged to reflect electromagnetic waves transmitted by a vehicle traveling on the infrastructure back towards the vehicle, each electromagnetic wave reflector comprises at least one resonator having at least one resonance mode to modify at least one of a power and a phase of the electromagnetic waves reflected by the electromagnetic wave reflectors, as a function of a frequency of the electromagnetic waves.

47. Device according to claim 46, wherein said at least one resonator is configured to encode information intended for the vehicle using at least one of the phase and an amplitude of the resonance modes of said at least one resonator.

48. Device according to claim 46, wherein the resonators have different resonance frequencies, each resonance frequency being associated to a different element of the infrastructure.

49. Device according to claim 46, wherein each electromagnetic wave reflector comprises at least one antenna whose directivity pattern is configured to collect radiation in a plane substantially parallel to a roadway of the infrastructure and in a principal direction substantially perpendicular to the direction of travel.

50. Device according to claim 46 arranged within a composition of ground markings.

51. Device according to claim 46, wherein the frequency of the reflected electromagnetic waves is below 1 GHz.
